(19) United States
(12) Patent Application Publication
(10) Pub. No.: US 2010/0014193 A1
(43) Pub. Date: Jan. 21, 2010

(54) LAMP MEMBER FOR STORAGE DISK DRIVE, STORAGE DISK DRIVE, AND METHOD FOR DETECTING POSITION OF HEAD ACTUATOR

(75) Inventor: Hiroshi Satou, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki (JP)

(21) Appl. No.: 12/570,240

(22) Filed: Sep. 30, 2009

Related U.S. Application Data
(63) Continuation of application No. PCT/JP2007/060731, filed on May 25, 2007.

(51) Int. Cl. G11B 5/48

(52) U.S. Cl. 360/244; G9B/5.147

(57) ABSTRACT

According to one embodiment, a storage disk drive includes a housing, a storage disk, a head actuator, a load tab, a ramp member, a magnetic pattern, and an electromagnetic transducer device. The storage disk is housed in the housing. The head actuator is housed in the housing to be swingable around a support shaft, and includes an end facing the storage disk. The load tab is supported by the end of the head actuator. The ramp member is fixed to the housing outside the storage disk, and defines a passage of the load tab along a circular arc drawn with a predetermined curvature. The magnetic pattern includes magnetic poles arranged on the ramp member along the passage. The electromagnetic transducer device is supported by the end of the head actuator, and reads the magnetic poles on the ramp member.

### CROSS-REFERENCE TO RELATED APPLICATIONS

This application is a continuation of PCT international application Ser. No. PCT/JP2007/060731 filed on May 25, 2007 which designates the United States, incorporated herein by reference.

### BACKGROUND

1. Field

One embodiment of the invention relates to a storage disk drive.

2. Description of the Related Art

In the field of storage disk drives such as hard disk drives (HDD), a ramp load system is widely known. In the ramp load system, a load tab is formed at an end of a head actuator, i.e., a head suspension. A ramp member is arranged on a moving path of the load tab and outside the magnetic disk. When rotation of the magnetic disk stops, the load tab is received by the ramp member. The head slider on the head suspension is separated from the magnetic disk. This prevents the contact of the head slider with the magnetic disk during the stop of the magnetic disk.

Movement of the head suspension is achieved by the operation of a voice coil motor (VCM). According to the movement of the head suspension, the load tab is separated from the ramp member. In separation of the load tab, back electromotive force of the VCM is measured. The moving speed of the load tab is estimated according to the magnitude of the back electromotive force. The moving speed of the load tab is set to a desired target value. Reference may be had to, for example, Japanese Patent Application Publication (KOKAI) No. 2003-141839.

The back electromotive force of the VCM is very small, and is difficult to be measured accurately. The moving speed of the load tab varies according to measurement error. When the load tab moves too fast, the head slider faces the surface of the magnetic disk before sufficient buoyancy is generated. The head slider runs into the magnetic disk. On the other hand, when the load tab moves too slowly, an air flow acts vigorously upon the head slider before separation of the load tab. This results in fluttering of the head slider, thereby causing a collision between the head slider and the magnetic disk.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view schematically illustrating an internal structure of a hard disk drive (HDD) according to a first embodiment of the invention;

FIG. 2 is an exemplary enlarged perspective view of a flying head slider in the first embodiment;

FIG. 3 is an exemplary enlarged perspective view of a ramp member in the first embodiment;

FIG. 4 is an exemplary enlarged side view of the ramp member in the first embodiment;

FIG. 5 is an exemplary block diagram schematically illustrating the control system of a voice coil motor (VCM) in the first embodiment;

FIG. 6 is an exemplary plan view schematically illustrating an internal structure of a HDD according to a second embodiment of the invention;

FIG. 7 is an exemplary enlarged perspective view of a ramp member in the second embodiment; and

FIG. 8 is an exemplary block diagram schematically illustrating the control system of a VCM in the second embodiment.

### DETAILED DESCRIPTION

Various embodiments according to the invention will be described hereinafter with reference to the accompanying drawings. In general, according to one embodiment of the invention, a storage disk drive comprises a housing, a storage disk, a head actuator, a load tab, a ramp member, a magnetic pattern, and an electromagnetic transducer device. The storage disk is configured to be housed in the housing. The head actuator is configured to be housed in the housing to be swingable around a support shaft, and includes an end facing the storage disk. The load tab is configured to be supported by the end of the head actuator. The ramp member is configured to be fixed to the housing outside the storage disk, and define a passage of the load tab along a circular arc drawn with a predetermined curvature. The magnetic pattern comprises magnetic poles arranged on the ramp member along the passage. The electromagnetic transducer device is configured to be supported by the end of the head actuator, and read the magnetic poles on the ramp member.

According to another embodiment of the invention, a ramp member for a storage disk drive comprises a main body and a magnetic pattern. The main body is configured to define a passage of a load tab along a circular arc drawn with a predetermined curvature. The magnetic pattern comprises magnetic poles arranged along the passage.

According to still another embodiment of the invention, a storage disk drive comprises a housing, a storage disk, a head actuator, a conductive load tab, a ramp member, a resistor, and a control circuit. The storage disk is configured to be housed in the housing. The head actuator is configured to be housed in the housing to be swingable around a support shaft, and includes an end facing the storage disk. The conductive load tab is configured to be supported by the end of the head actuator. The ramp member is configured to be fixed to the housing outside the storage disk, and define a passage of the load tab along a circular arc drawn with a predetermined curvature. The resistor is configured to cause a current to flow along the passage. The control circuit is configured to detect a resistance value of the resistor.

According to still another embodiment of the invention, a ramp member for a storage disk drive comprises a main body and a resistor. The main body is configured to define a passage of a load tab along a circular arc drawn with a predetermined curvature. The resistor is configured to cause a current to flow along the passage.

According to still another embodiment of the invention, there is provided a method for detecting a position of a head actuator. The method comprises detecting a magnetic field from a magnetic pattern comprising magnetic poles arranged along a passage of a load tab on a ramp member with an electromagnetic transducer device supported by the head actuator while the load tab supported by the head actuator moves on the ramp member.

According to still another embodiment of the invention, there is provided a method for detecting a position of a head actuator. The method comprises: flowing a current through a resistor extending along a circular arc with a predetermined curvature on a ramp member; moving a conductive load tab supported by the head actuator on the resistor according to movement of the head actuator; and detecting a change in resistance of the resistor.

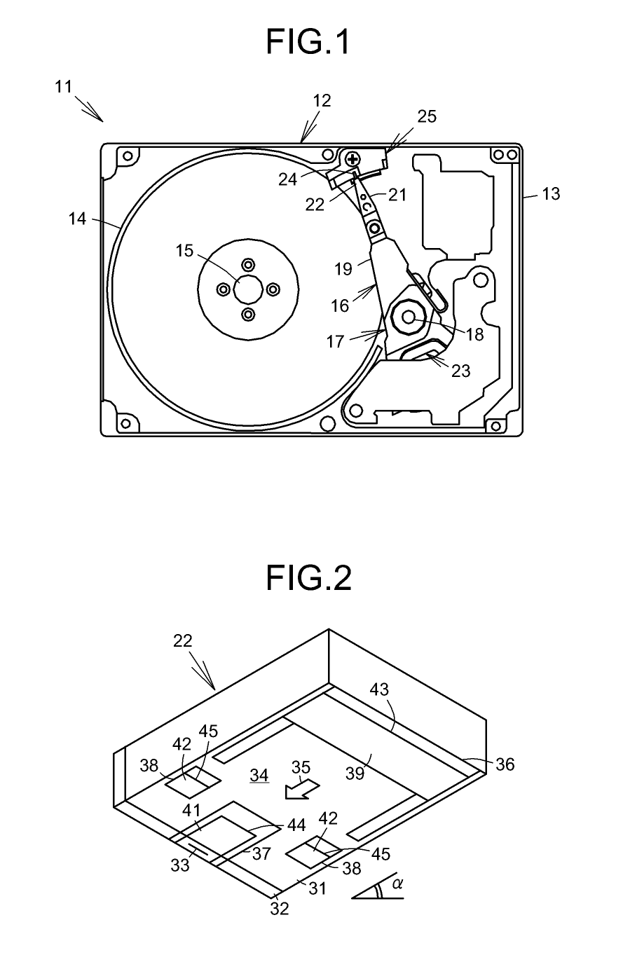

FIG. 1 schematically illustrates an internal structure of a hard disk drive (HDD) 11 as an example of a storage medium drive according a first embodiment of the invention. The HDD 11 comprises a housing 12. The housing 12 comprises a box-shaped base 13 and a cover (not illustrated). The base 13 defines, for example, a flat rectangular parallelepiped internal space, i.e., a housing space. The base 13 may be formed of a metal material such as, for example, aluminum by casting. The cover is connected to an opening of the base 13. The housing space is sealed between the cover and the base 13. The cover may be formed by, for example, pressing a piece of plate.

In the housing space, at least one magnetic disk 14 as a storage medium is housed. The magnetic disk 14 is mounted on the rotation shaft of a spindle motor 15. The spindle motor 15 can rotate the magnetic disk 14 at high speed, such as 5400 rpm, 7200 rpm, 10000 rpm, or 15000 rpm.

In the housing space, a carriage 16 is further housed. The carriage 16 comprises a carriage block 17. The carriage block 17 is rotatably connected to a support shaft 18. In the carriage block 17, a plurality of carriage arms 19 extending horizontally from the support shaft 18 are defined. The carriage block 17 may be formed by, for example, extruding aluminum.

Attached to an end of each of the carriage arms 19 is a head suspension 21. The head suspension 21 extends forward from the end of the carriage arm 19. A flexure is affixed to the head suspension 21. A flying head slider 22 is mounted on the surface of the flexure at an end of the head suspension 21. A gimbal screw is defined on the flexure. Due to the action of the gimbal screw, the flying head slider 22 can change its posture with respect to the head suspension 21.

When an air flow is generated on the surface of the magnetic disk 14 by rotation of the magnetic disk 14, positive pressure, i.e., buoyancy, and negative pressure act on the flying head slider 22 by the action of the air flow. When the buoyancy, the negative pressure, and a pressing force of the head suspension 21 are in balance, the flying head slider 22 can keep floating at relatively high stiffness during the rotation of the magnetic disk 14.

The carriage block 17 is connected to a voice coil motor (VCM) 23. Due to the operation of the VCM 23, the carriage block 17 can rotate about the support shaft 18. With this rotation of the carriage block 17, the carriage arm 19 and the head suspension 21 can swing. When the carriage arm 19 swings about the support shaft 18 while the flying head slider 22 is floating, the flying head slider 22 can move across the surface of the magnetic disk 14 radially. Through such movement of the flying head slider 22, an electromagnetic transducer device can be positioned on a target recording track.

Fixed to an end of the head suspension 21 is a load tab 24 which is a long member extending forward from the end of the head suspension 21. The load tab 24 can move in a radial direction of the magnetic disk 14 based on the swing of the carriage arm 19. On the moving path of the load tab 24, a ramp member 25 is arranged outside the magnetic disk 14. The load tab 24 is received by the ramp member 25. The ramp member 25 and the load tab 24 cooperate to form a load/unload mechanism. The ramp member 25 will be described in detail later.

FIG. 2 illustrates an example of the flying head slider 22. The flying head slider 22 comprises a slider main body 31 made of AL₂O₃—TiC (AlTiC) and formed in a flat rectangular-parallelepiped shape. On an end surface of the slider main body 31 at air outflow side, a head element built-in film 32 made of AL₂O₃ (Alumina) is laminated. An electromagnetic transducer device 33 is embedded in the head element built-in film 32. The slider main body 31 faces the magnetic disk 14 by a medium facing surface, i.e., a flying surface 34. On the flying surface 34, a flat base surface, i.e., a reference surface, is defined. When the magnetic disk 14 rotates, an air flow 35 acts on the flying surface 34 from the front end to the rear end of the slider main body 31.

The electromagnetic transducer device 33 comprises, for example, a writing element and a reading element. A thin film magnetic head may be used as the writing element. The thin film magnetic head generates a magnetic field by operation of a thin film coil pattern. With the magnetic field, data is written to the magnetic disk 14. On the other hand, a giant magnetic resistance (GMR) element or a tunnel junction magnetic resistance (TMR) element may be used as the reading element. In the GMR element or TMR element, resistance change of the tunnel junction film or spin valve film is caused according to a direction of the magnetic field acted by the magnetic disk 14. According to such resistance change, the information is read from the magnetic disk 14.

On the flying surface 34 of the slider main body 31 are formed a front rail 36 rising from the base surface at the upstream side of the air flow 35, i.e., air inflow side, a rear center rail 37 rising from the base surface at the downstream side of the air flow 35, i.e., the air outflow side, and a pair of rear side rails 38, 38 rising from the base surface at the air outflow side. On top surfaces of the front rail 36, the rear center rail 37 and the rear side rails 38, 38, air bearing surfaces (ABSs) 39, 41 and 42 are defined. The air inflow ends of the ABSs 39, 41 and 42 are connected to the top surfaces of the rails 36, 37 and 38 at their step portions 43, 44 and 45.

The air flow 35 generated by rotation of the magnetic disk 14 is received by the flying surface 34. Then, the step portions 43, 44 and 45 operate to generate relatively large positive pressure, i.e., buoyancy, on the ABSs 39, 41 and 42. Besides, large negative pressure is generated backward, i.e., behind the front rail 36. According to the balance between the buoyancy and negative pressure, flying attitude of the flying head slider 22 is stabilized.

A read gap of the reading element and a write gap of the writing element are exposed on the ABS 41 of the rear center rail 37. However, on the surface of the ABS 41, there may be a diamond like carbon (DLC) protective film formed to cover the read gap and write gap. Note that the form of the flying head slider 22 is not limited to this.

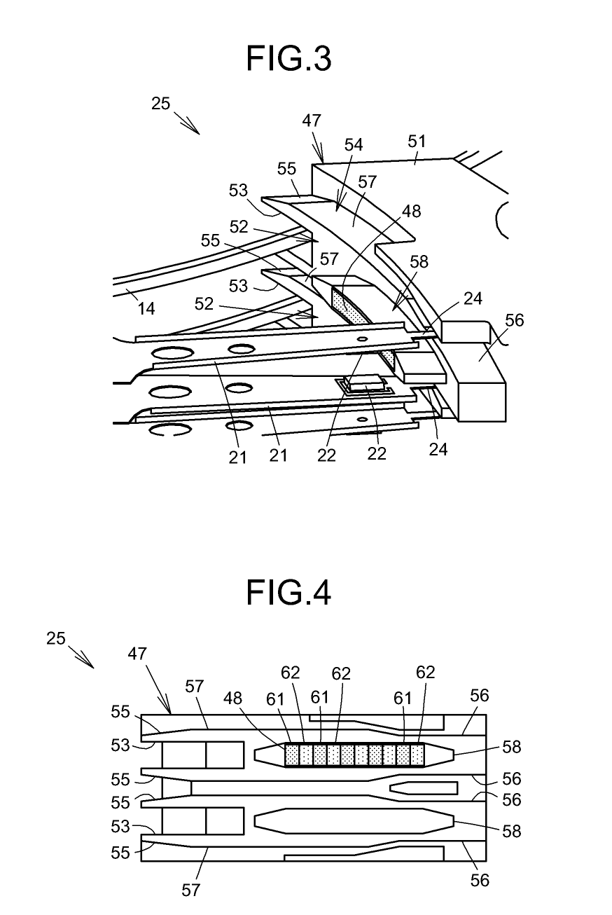

As illustrated in FIG. 3, the ramp member 25 comprises a ramp main body 47 made of, for example, a rigid plastic material and a magnetic body 48 embedded in the ramp main body 47. The ramp main body 47 comprises a mounting table 51 fixed to the bottom plate of the base 13 outside the magnetic disk 14. The mounting table 51 may be fastened to the base 13 by, for example, screws. On the mounting table 51, a projection 52 projecting along the horizontal surface toward the support shaft 18 of the carriage 16 is formed. For example, the projection 52 is formed integral with the mounting table 51 by integral molding. In the mounting table 51 and the projection 52, a receiving groove 53 is formed, in which the magnetic disk 14 is received.

In the upward and downward surfaces of the projection 52, the guiding paths 54 and 54 are defined. Each guiding path 54 extends along an arc drawn with a predetermined curvature around the support shaft 18. Accordingly, when the carriage 16 swings around the support shaft 18, the load tab 24 can move on the guiding path 54 from the inner end to the outer end. In this way, the guiding path 54 forms a path of the load tab 24.

The guiding path 54 comprises a first guiding path 55 extending from the inner end of the guiding path 54 to the outside in the radial direction of the magnetic disk 14. The first guiding path 55 is gradually separated from the surface of the magnetic disk 14 toward the outside in the radial direction of the magnetic disk 14. A second guiding path 57 extending toward a recess 56 is formed outside the first guiding path 55. The second guiding path 57 is connected to the top end of the first guiding path 55, i.e., to the outside end.

The guiding path 54 may be coated with a lubricant. The lubricant may be, for example, Perfluoropolyether. For coating, for example, the ramp member 25 may be dipped in a liquid containing Perfluoropolyether. Otherwise, to mold the ramp member 25, the rigid plastic material may be previously impregnated with the lubricant. Such a lubricant prevents as much friction as possible between the load tab 24 and the guiding path 54. With the ramp member 25, abrasion dust is prevented from being generated.

On the projection 52, a small projection 58 further projecting horizontally toward the support shaft 18 of the carriage 16 is formed in the middle of the guiding paths 54. The small projection 58 is integral with the ramp main body 47 by integral molding, for example. The magnetic body 48 is embedded in the small projection 58. Therefore, when the load tab 24 moves along the guiding path 54, the magnetic force of the magnetic body 48 acts on the reading element on the flying head slider 22.

As illustrated in FIG. 4, in the magnetic body 48, mutually different magnetic poles, i.e., north (N) poles 61 and south (S) poles 62 are arranged alternately along the guiding path 54. Besides, on the circular arc around the support shaft 18, the widths of the N poles 61 and the S poles 62 are set to be equal to each other. As a result, if the load tab 24 moves on the guiding path 54 at the constant speed, a magnetic field of the N poles 61 and the S poles 62 acts on the reading element at fixed intervals. In this way, the magnetic pattern is formed on the ramp main body 47.

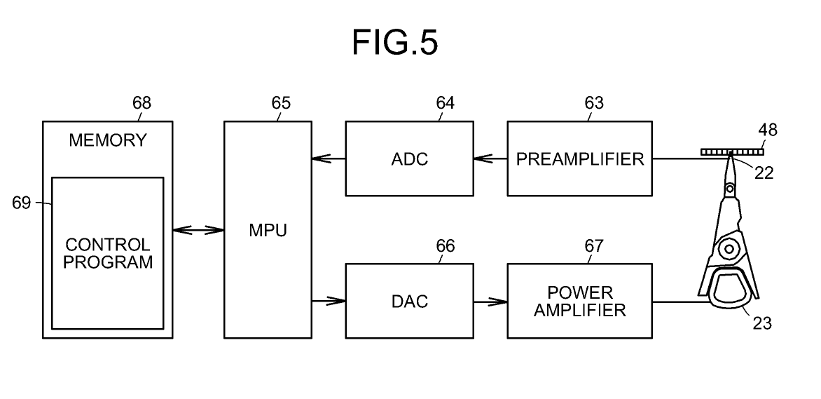

As illustrated in FIG. 5, a preamplifier 63 is connected to the reading element of the electromagnetic transducer device 33. The preamplifier 63 amplifies a voltage applied to the reading element. The preamplifier 63 is connected to an analog-to-digital converter (ADC) 64. The voltage output from the preamplifier 63 is converted into a digital signal by the ADC 64. A microprocessor unit (MPU) 65 is connected to the ADC 64. The MPU 65 specifies a resistance change of the reading element based on the digital signal. For measuring the voltage, for example, a constant current may be supplied from a constant current source to the reading element.

A digital-to-analog converter (DAC) 66 is connected to the MPU 65. The DAC 66 outputs an analog current based on the digital signal supplied from the MPU 65. A power amplifier 67 is connected to the DAC 66. The power amplifier 67 amplifies power. The power amplifier 67 is connected to the VCM 23. The VCM 23 is controlled based on the amplified power.

A memory 68 is connected to, for example, the MPU 65. The MPU 65 executes processing based on a control program 69 stored in the memory 68. The MPU 65 may be, for example, a digital signal processor (DSP). The MPU 65 may function as a hard disk controller (HDC).

It is assumed herein that magnetic information is read from the magnetic pattern on the magnetic disk 14. The MPU 65 rotates the spindle motor 15 at constant rotation speed. The magnetic disk 14 rotates. The flying head slider 22 faces the rotating magnetic disk 14. Between the surface of the magnetic disk 14 and the flying head slider 22, an air bearing is formed. The flying head slider 22 continues flying while the magnetic disk 14 is rotating.

The electromagnetic transducer device 33, i.e., the reading element, on the flying head slider 22 faces the magnetic pattern on the magnetic disk 14. According to change of magnetic poles leaked from the magnetic pattern, the electric resistance of the reading element changes. In this way, voltage change is read from the reading element. The MPU 65 specifies magnetic information based on the voltage change.

When reading of the magnetic information is completed, the MPU 65 retracts the flying head slider 22 from the magnetic disk 14. The MPU 65 supplies a predetermined amount of current to the VCM 23. The carriage 16 swings in the forward direction around the support shaft 18. As a result, the end of the head suspension 21 moves toward the outer edge of the magnetic disk 14. The load tab 24 moves to the outside of the magnetic disk 14 in the radial direction.

According to the swing of the carriage 16, the load tab 24 comes into contact with the guiding path 54 of the ramp member 25. The load tab 24 moves upward along the first guiding path 55. As the load tab 24 moves upward along the first guiding path 55, the flying head slider 22 is pulled up from the surface of the magnetic disk 14. Thus, the buoyancy and negative pressure of the flying head slider 22 disappear. The flying head slider 22 is supported on the ramp member 25 due to the action of the load tab 24. At this point, the MPU 65 may stop the rotation of the magnetic disk 14.

Then, as the carriage 16 continues swinging, the load tab 24 reaches the recess 56 from the second guiding path 57 on the ramp member 25. The MPU 65 stops supplying the current to the voice call motor 23. The carriage 16 stops swinging. The load tab 24 is held in the recess 56.

Here, as the load tab 24 moves toward the recess 56 from the second guiding path 57, specific one of the flying head sliders 22 moves along the magnetic body 48 of the ramp member 25. The magnetic field of the N poles 61 and the S poles 62 of the magnetic body 48 acts on the reading element on the flying head slider 22. According to a change in magnetic poles, the electric resistance of the reading element varies. Thus, voltage change is read from the reading element. The MPU 65 specifies magnetic information based on the voltage change.

In the magnetic body 48, the N poles 61 and the S poles 62 are arranged alternately. Therefore, the position of the load tab 24 can be specified in the second guiding path and the recess 56 based on the magnetic information. The MPU 65 specifies the moving speed of the load tab 24 based on the specified position and the elapsed time. The MPU 65 controls the amount of current supplied to the VCM 23 based on the moving speed. Accordingly, the rotation speed of the carriage 16 is controlled. The moving speed of the load tab 24 is set to a desired value. The swing of the carriage 16 is securely stopped at the limit position of swing.

On the other hand, for example, when the load tab 24 moves too fast, the carriage 16 reaches the limit position of swing at a furious pace. The carriage 16 rebounds from the limit position. By back action, the carriage 16 starts swinging in a direction opposite to the forward direction. It is sometimes the case that, with too furious pace, the flying head slider 22 may fall on the surface of the stopped magnetic disk 14.

Upon start of reading, the MPU 65 first starts rotating the magnetic disk 14. When the rotation of the magnetic disk 14 reaches a steady state, the MPU 65 supplies a predetermined amount of current to the VCM 23. As a result, the carriage 16 starts swinging in the backward direction. The load tab 24 moves from the recess 56 to the second guiding path 57. After passing through the second guiding path 57, the load tab 24 reaches the first guiding path 55. The load tab 24 moves down along the first guiding path 55. The flying head slider 22 gradually moves closer to the surface of the magnetic disk 14. When sufficient air flow acts on the flying head slider 22 from the magnetic disk 14, buoyancy is generated on the flying head slider 22. Between the flying head slider 22 and the surface of the magnetic disk 14, an air bearing is generated. Then, when the load tab 24 separates from the first guiding path 55, the flying head slider 22 continues flying due to action of the air bearing.

As passing through the second guiding path 57, specific one of the flying head sliders 22 moves along the magnetic body 48 of the ramp member 25. As described above, the magnetic field of the N poles 61 and the S poles 62 of the magnetic body 48 acts on the reading element on the flying head slider 22. According to a change in magnetic pole, the electric resistance of the reading element varies. Thus, voltage change is read from the reading element. The MPU 65 specifies magnetic information based on the voltage change. Based on the specified magnetic information, the MPU 65 controls the moving speed of the load tab 24. Accordingly, the moving speed of the load tab 24 is set to a desired value. On the flying head slider 22, the buoyancy is generated reliably.

On the other hand, for example, when the load tab 24 moves too fast, the buoyancy on the flying head slider 22 cannot be sufficient before the separation of the load tab 24. Accordingly, when the load tab 24 separates from the first guiding path 55, a negative pressure is first generated on the flying head slider 22 before the buoyancy is generated. The flying head slider 22 is attracted to the magnetic disk 14 excessively. As a result, the flying head slider 22 runs into the surface of the magnetic disk 14. Due to this, the electromagnetic transducer device 33 may be broken and the magnetic disk may be damaged.

On the other hand, when the load tab 24 moves too slowly, the air flow vigorously acts upon the flying head slider 22 before the separation of the load tab 24. The buoyancy and negative pressure are generated on the flying head slider 22. Since the load tab 24 is still supported on the ramp member 25, the flying head slider 22 flutters due to the buoyancy and negative pressure. The attitude of the flying head slider 22 varies frequently. As a result, the flying head slider 22 and the magnetic disk 14 may collide.

In the HDD 11 described above, the ramp member 25 may be provided with the magnetic body 48 with respect to each of the flying head sliders 22. In this case, the moving speed of the load tab 24 may be measured in advance for each of the flying head sliders 22. The swing speed of the carriage 16 may be set based on measured values commonly for all the flying head sliders 22. The set swing speed may be stored in, for example, the memory 68.

In the first embodiment, the flying head slider 22 may be provided with a dedicated electromagnetic transducer device for reading the N poles 61 and the S poles 62 in addition to the electromagnetic transducer device 33. Besides, the magnetic body 48 may be embedded in, for example, the guiding path 54. In this case, in addition to the electromagnetic transducer device 33, the dedicated electromagnetic transducer device may be fixed to the load tab 24.

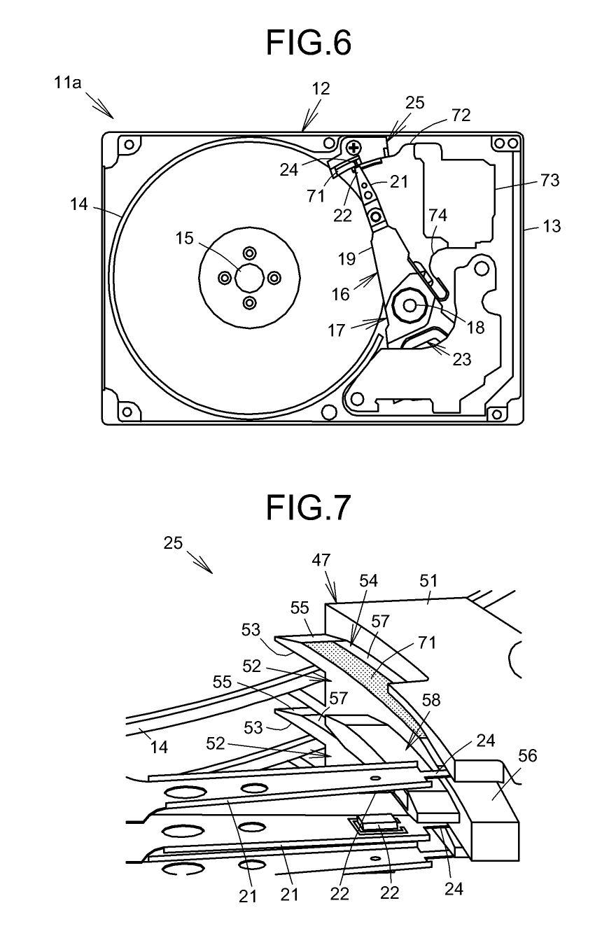

FIG. 6 schematically illustrates a structure of an HDD 11a according to a second embodiment of the invention. In the HDD 11a, a resistor 71 is embedded in the ramp member 25. To the resistor 71, one wiring pattern on a flexible printed board 72 is connected. The wiring pattern on the flexible printed board 72 is connected to a small printed board 73. In the printed board 73, a connector (not illustrated) is embodied. The connector penetrates through the bottom plate of the base 13. Fixed to the back side of the base 13, is a control printed board (not illustrated). To the connector, the control printed board is connected. Thus, the wiring pattern on the flexible printed board 72 is electrically connected to an electronic circuit on the control printed board.

The load tab 24 is made of a conductive material such as metal. To the load tab 24, the wiring pattern on the flexure is connected. The wiring pattern of a flexure is connected to a flexible printed board 74 on the carriage block 17. This flexible printed board 74 is connected to the printed board 73. The load tab 24 is electrically connected to an electronic circuit on the control printed board.

As illustrated in FIG. 7, the resistor 71 extends from the inner end to the outer end along the guiding path 54. The resistor 71 may extend from the first guiding path 55 to the recess 56. The resistor 71 may have uniform cross section. The resistor 71 may be formed of, for example, resistance paste. For the resistance paste, for example, heat-hardening resin may be mixed with carbon filler.

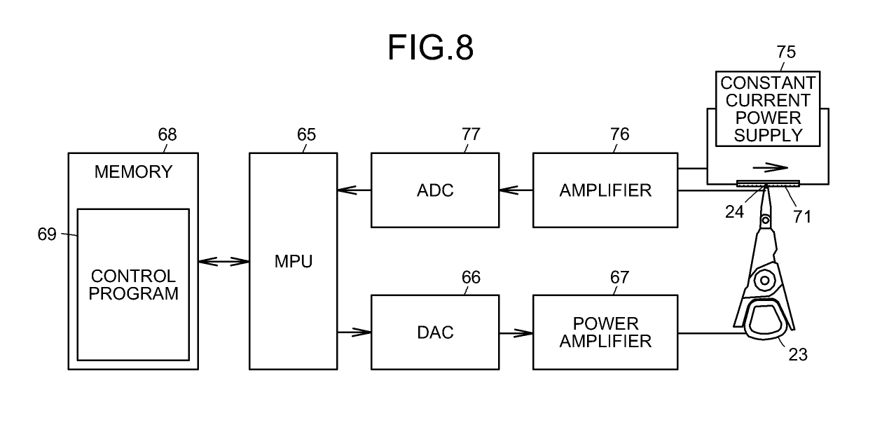

As illustrated in FIG. 8, to the resistor 71, a constant current power supply 75 is connected. The constant current power supply 75 establishes a current passage over the entire length of the resistor 71. An amplifier 76 is connected to the inner end of the resistor 71 and the load tab 24. The amplifier 76 amplifies a voltage varying between the resistor 71 and the load tab 24. When the load tab 24 moves toward the outer end, a resistance value of the resistor 71 increases. According to the increase in resistance value, the voltage increases. As the cross-sectional area of the resistor 71 is kept uniform, the moving distance of the load tab 24 and the voltage are in proportional relation. The amplifier 76 is connected to an ADC 77, which is then connected to the MPU 65. Besides, constituent elements corresponding to those previously described in the first embodiment are designated by like reference numerals.

When the reading of magnetic information is completed, the MPU 65 retracts the flying head slider 22 from the magnetic disk 14. As described above, through the swing of the carriage 16, the load tab 24 comes into contact with the guiding path 54 of the ramp member 25. The load tab 24 moves up along the first guiding path 55. Then, the load tab 24 passes through the second guiding path 57 and reaches the recess 56. During this course, the load tab 24 is kept in contact with the guiding path 54. That is, the load tab 24 moves on the resistor. As a result, a voltage emerging on the amplifier increases. According to such voltage change, the MPU 65 specifies the position of the load tab 24. Based on the specified position and elapsed time, the moving speed of the load tab 24 is specified. Based on the moving speed, the MPU 65 controls the current supplied to the VCM 23. The rotation speed of the carriage 16 is thus controlled. The moving speed of the load tab 24 is set to a desired value.

Upon start of reading, the MPU 65 instructs the carriage 16 to swing. The load tab 24 moves from the recess 56 to the second guiding path 57 and then to the first guiding path 55. During this course, the load tab 24 moves on the resistor. As a result, a voltage emerging on the amplifier decreases. Based on such voltage change, the MPU 65 specifies the position of the load tab 24. Based on the specified position and elapsed time, the moving speed of the load tab 24 is specified. Based on the moving speed, the MPU 65 controls the current supplied to the VCM 23. The rotation speed of the carriage 16 is thus controlled. The moving speed of the load tab 24 is set to a desired value.

As described above, according to an embodiment of the invention, when a storage disk stops, the head actuator, i.e., the head suspension, swings around the support shaft. An end of the head actuator is retracted outside the storage disk. At this point, when the load tab moves along the passage on the ramp member, the electromagnetic transducer device reads magnetic poles on the ramp member. According to the a change in magnetic pole, the position of the load tab on the ramp member can be specified. Based on the specified position and elapsed time, the moving speed of the load tab can be specified. The swing of the head actuator can be controlled based on the moving speed.

In such a storage disk drive, the electromagnetic transducer device may read a signal from a magnetic pattern on the storage disk. That is, the general reading element may be used to read magnetic poles on the ramp member. As a result, the electromagnetic transducer device dedicated to the ramp member may be eliminated. Thus, wiring complexity of the head actuator can be avoided.

The magnetic pattern may have N poles and S poles arranged alternately along the circular arc. With this arrangement, change in magnetic pole can be realized reliably. The position of the load tab can be specified reliably.

In realization of such storage disk drive, a specific ramp member may be provided. This ramp member may comprise, for example, a ramp main body defining a passage of the load tab along the circular arc drawn with a predetermined curvature and a magnetic pattern having magnetic poles arranged along the passage.

When a storage disk stops, the head actuator, i.e., the head suspension, swings around the support shaft. An end of the head actuator is retracted outside the storage disk. At this point, when the load tab moves along the passage on the ramp member, a resistance value between the load tab and the resistor changes. According to such change in resistance value, the position of the load tab on the ramp member can be specified. Based on the specified position and elapsed time, the moving speed of the load tab can be specified. The swing of the head actuator can be controlled based on the moving speed.

The resistor may be embedded in the passage. The resistance value between the load tab and the resistor sufficiently changes if the resistor may be embedded in the passage. Besides, the wear of the resistance can be prevented.

Realization of such a storage disk drive provides a specific ramp member. This ramp member may comprise, for example, a ramp main body defining a passage of the load tab along the circular arc drawn with a predetermined curvature and a resistor for flowing current along the passage.

Moreover, displacement of the head actuator can be controlled based on the moving speed of the load tab.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A storage disk drive comprising:
a housing;
a storage disk configured to be housed in the housing;
a head actuator configured to be housed in the housing to be swingable around a support shaft, the head actuator including an end facing the storage disk;
a load tab configured to be supported by the end of the head actuator;
a ramp member configured to be fixed to the housing outside the storage disk, and define a passage of the load tab along a circular arc drawn with a predetermined curvature;
a magnetic pattern comprising magnetic poles arranged on the ramp member along the passage; and
an electromagnetic transducer device configured to be supported by the end of the head actuator, and read the magnetic poles on the ramp member.

2. The storage disk drive of claim 1, wherein the electromagnetic transducer device is configured to read a signal from the magnetic pattern on the storage disk.

3. The storage disk drive of claim 1, wherein the magnetic pattern comprises north poles and south poles arranged alternately along the circular arc.

4. A ramp member for a storage disk drive comprising:
a main body configured to define a passage of a load tab along a circular arc drawn with a predetermined curvature; and
a magnetic pattern comprising magnetic poles arranged along the passage.

5. The ramp member of claim 4, wherein the magnetic pattern comprises north poles and south poles arranged alternately along the circular arc.

6. A storage disk drive comprising:
a housing;
a storage disk configured to be housed in the housing;
a head actuator configured to be housed in the housing to be swingable around a support shaft, the head actuator including an end facing the storage disk;
a conductive load tab configured to be supported by the end of the head actuator;
a ramp member configured to be fixed to the housing outside the storage disk, and define a passage of the load tab along a circular arc drawn with a predetermined curvature;
a resistor configured to cause a current to flow along the passage; and
a control circuit configured to detect a resistance value of the resistor.

7. The storage disk drive of claim 6, wherein the resistor is embedded in the passage.
